(19) United States
(12) Patent Application Publication
(10) Pub. No.: US 2010/0127862 A1
(43) Pub. Date: May 27, 2010

(54) ELECTRONIC KEY

(75) Inventors: Akihiro Sato, Seki-shi (JP); Nobuhiko Segi, Motosu-shi (JP)

Correspondence Address: OLIFF & BERRIDGE, PLC, P.O. BOX 320850, ALEXANDRIA, VA, 22320-4850, US

(73) Assignee: TOKAI RIKEN CO., LTD., Seki-shi, Gifu (JP)

(21) Appl. No.: 12/596,064

(22) PCT Filed: Oct. 15, 2008
(86) PCT No.: PCT/JP2008/068626

§ 371 Date: Oct. 15, 2009

(30) Foreign Application Priority Data
Oct. 30, 2007 (JP) 2007-281921
Oct. 7, 2008 (JP) 2008-261069

(51) Int. Cl. H04L 9/32; G08C 19/00; E05B 65/44

(52) U.S. Cl. 340/540; 340/5.6; 70/78

(57) ABSTRACT

To provide an electronic key capable of easily checking whether or not data has been read from a contact IC chip and enhance reliability of security, an electronic key includes a contact IC chip connected in series to first and second terminals so that data is read from the IC chip by a current allowed to flow between the first and second terminals, wherein the electronic key comprises an LED arranged in parallel to the contact IC chip and allowed to turn on through use of the current allowed to flow between the first and second terminals when the first and second terminals contact with IC chip data reading means, and turn-on of the LED indicates that data has been read from the contact IC chip.

### TECHNICAL FIELD

The present invention relates to an electronic key having a contact IC chip which is connected in series to a plurality of terminals, the electronic key being adapted to read data from the contact IC chip by an electric current (“current”) flowing from an IC chip data reading means between the terminals when the terminals contact with the IC chip data reading means.

### BACKGROUND ART

In offices, conventionally, keys for opening and closing corresponding storage boxes of each storage cabinet are stored in a key management box. In using one of the keys, a user opens a door of the key management box after authentication using an ID card or the like and takes out a key to a storage box the user intends to use. The key management box permits the door to be opened only when the user is ID-authenticated with the ID card and has the access right for the subject storage box.

However, it is troublesome to separately bring the ID card and the key. When a user wants to check or get documents in many storage boxes, the user has to bring around many keys. This is poor in working efficiency. To solve such problems, there is a demand for a system capable of opening and closing a plurality of storage boxes by use of one same key.

As the system for opening and closing storage boxes of a plurality of storage cabinets by using the same single key, a master key has been known. The master key is able to open and close all the storage cabinets but it is intended for emergency, e.g., if any individual key is lost. If the master key is daily used, it is meaningless to provide different locks to different storage boxes to keep stored articles. Furthermore, it is impossible to set an access right for each storage box to each person.

In this regard, there is a commercially available configuration using replaceable cylinder locks so that different locks are set in different storage boxes and the storage boxes are permitted to be opened and closed with a single key. For easily changing a relation between a cylinder lock and a key, there is an electronic key configured by a combination of an IC chip and a key. Accordingly, storage boxes permitted to be opened and closed by a single electronic key are arbitrarily set and changed. The electronic key is harder to be duplicated and hence provides higher security as compared with a mechanical key.

For instance, a technique disclosed in Patent Literature 1 is arranged such that a lock is provided in a door of a storage box and is locked against rotation by a solenoid. The electronic key includes a grip portion containing a contact IC chip and an insert portion to be inserted in the lock. When the insert portion of the electronic key is inserted in the lock, a key-side data terminal of the contact IC chip contacts with a door-side data terminal of the door, and ID data is read out from the IC chip by a control unit in the door. When the ID data of the IC chip coincides with properly registered ID data, the control unit energizes the solenoid to release or unlock the lock from a rotation-inhibiting state. Accordingly, the electronic key is permitted to rotate the lock to thereby lock and unlock the door. On the other hand, in case the ID data of the IC chip does not coincide with the properly registered ID data, the control unit does not energize the solenoid and does keep the lock in the rotation-inhibiting state. Thus, the electronic key is not permitted to rotate the lock to lock and unlock the door.

### Citation List

### Patent Literature

### Patent Literature 1: JP10 (1998)-252327A

### SUMMARY OF INVENTION

### Technical Problem

However, for instance, in the case where the electronic key disclosed in Patent Literature 1 could not unlock the lock of the storage box even though the key is inserted in the lock, there is no means for informing a user of such an operating state of the electronic key.

The electronic key is configured for example such that the contact IC chip is connected in series between two key-side terminals and data is read by a current flowing between the two key-side terminals. Each terminal is made of metal such as copper and hence apt to be formed with a surface film due to oxidation. If the surface film is formed on each terminal, the terminals do not allow a current to flow therethrough and therefore no current flows in the IC chip. In case a contact failure occurs in each key-side terminal, accordingly, data in the IC chip of the electronic key could not be read by the IC chip data reading means. Thus, the lock of the storage box could not be unlocked.

This surface film is easily removed for example by putting the electronic key in and out of the lock twice or three times so as to rub the key-side terminals with the door-side terminals or by scraping the surface of the key-side terminals with nails. In case the lock could not be unlocked due to a contact failure, therefore, a user has only to remove the surface film from the key-side terminals and insert the electronic key again in the lock. This makes it possible to eliminate a failure of reading data from the IC chip and unlock the lock.

Nevertheless, if the electronic key in the above Literature could not unlock the lock, the user could not know an operating state of the electronic key. Accordingly, when the lock could not be unlocked due to a contact failure of the key-side terminals, for example, the user would go from an installation site of the storage cabinet to an administrator of the electronic key to reinstall data in the electronic key. This is not an appropriate response to each cause of functional disorder of the electronic key. In this case, the user could not unlock the lock even after data reinstallation of the electronic key and hence might erroneously understand the electronic key was broken and wastefully exchange it for a new one. Consequently, for the electronic key, some method is needed for informing the user of a data reading failure whereby data could not be read properly from the contact IC chip.

Herein, in Japanese Patent No. 4049795 (Patent appl. No. 2006-123955 filed on Apr. 27, 2006) and published under a publication No. 2007-297771 on Nov. 15, 2007), the applicant of the present application has proposed a technique of indicating a data reading failure of a contact IC chip.

Specifically, the above patent relates to a storage cabinet for storing a plurality of articles, each of which is provided with a contact IC chip including two terminals and an LED which is connected to the IC chip in parallel therewith and is turned on by use of a current flowing between the two terminals. According to the above patent, therefore, when an article(s) is to be stored in the storage cabinet, the LED is not turned on to indicate to the user that data is not readable from the contact IC chip.

However, the above patent is intended to check whether or not the storage cabinet detects return of the article(s) when the article(s) is returned into the storage cabinet. Thus, the patent application of the above patent did not describe nor suggest indicating a user an operating state of the electronic key by distinguishing the operating state.

The present invention has been made to solve the above problems and has a purpose to provide an electronic key capable of indicating a user an operating state by distinguishing the operating state.

### Solution to Problem

To achieve the above purpose, the present invention provides an electronic key comprising the following configurations.

(1) In electronic key including a contact IC chip connected in series to a plurality of terminals so that when the terminals contact with an IC chip data reading means, data is readable from the IC chip by a current flowing between the terminals from the IC chip data reading means, the electronic key comprises an LED arranged in parallel to the contact IC chip and caused to turn on through use of the current flowing between the terminals when the terminals contact with the IC chip data reading means, and turn-on of the LED indicates that data has been read from the contact IC chip by the IC chip data reading means.

(2) In the invention set forth in (1), the LED is turned on in different light emitting modes between a case where proper authority is authenticated based on the data read from the contact IC chip and a case where proper authority is not authenticated based on the data read from the contact IC chip.

(3) In the invention set for the in (1) or (2), the electronic key comprises an IC unit internally containing the contact IC chip and the LED and holding the terminals protruding outside thereof, and the IC unit includes a cutout portion through which light of the LED goes out, the cutout portion being located on an opposite side to a protruding position of the terminals.

(4) In the invention set forth in one of (1) to (3), a circuit is formed between the terminals so that a current allowed to flow in the contact IC chip and a current allowed to flow in the LED are opposite in direction, and the electronic key comprises a circuit switching means that switches polarities of the terminals by a control signal to be transmitted from the IC chip data reading means and alternately performs driving of the contact IC chip and turn-on of the LED.

### ADVANTAGEOUS EFFECTS OF INVENTION

The electronic key having the above configuration comprises the contact IC chip connected in series with the plurality of terminals, so that data of the IC chip is read by a current flowing between the terminals. The electronic key includes the LED arranged in parallel with the IC chip and is configured such that the LED is turned on by use of the current flowing between the terminals.

To unlock a lock of a storage box, for instance, the above electronic key is inserted in the lock of the storage box so that the terminals contact with the IC chip data reading terminals. The electronic key with the LED turned on indicates to a user that the terminals are properly contact with the IC chip data reading means and the data has been properly read from the IC chip. Accordingly, in case the lock of the storage box is not permitted to be unlocked, the user considers a cause thereof as resulting from something other than a contact failure.

On the other hand, the electronic key with the LED turned off indicates to a user that the terminals are out of proper contact with the IC chip data reading means and hence data could not be read properly from the IC chip. In case the lock of the storage box is not permitted to be unlocked, therefore, the user considers the cause thereof as resulting from contact failure.

According to the electronic key of the invention, consequently, it is possible to indicate to a user an operating state by distinguishing the operating state.

The electronic key of the invention has different light emitting modes of the LED between the case where proper authority is authenticated based on the data read from the IC chip and the case where proper authority is not authenticated based on the data read from the IC chip. Based on the differences in light emitting mode of the LED, it is accordingly possible to indicate to a user whether authentication is successful.

The electronic key of the invention includes the IC unit containing the contact IC chip and the LED internally and holding the plurality of terminals protruding outside thereof. The IC unit is provided with the cutout portion for allowing LED's light to go out on the opposite side to the protruding position of the terminals. Accordingly, even when the electronic key is inserted in the lock, a light emitting state of the LED is easy to see.

The electronic key of the invention is formed with a circuit between the terminals so that a current allowed to flow in the contact IC chip and a current allowed to flow in the LED are opposite in direction, and the key includes the circuit switching means for switching the polarities of the terminals in response to the signal transmitted from the IC chip data reading means and alternately driving of the IC chip and turn-on of the LED. This electronic key can easily change the light emitting mode of the LED by distinguishing among a contact failure, an authentication failure, and an authentication success.

### BRIEF DESCRIPTION OF DRAWINGS

FIG. 1 is an external perspective view of a lockable storage cabinet in a first embodiment of the invention;

FIG. 2 is an electrical block diagram of a lock control means shown in FIG. 1;

FIG. 3 is a plan view of an electronic key shown in FIG. 1;

FIG. 4 is a side view seen from an arrow A in FIG. 3;

FIG. 5 is a side view seen from an arrow B in FIG. 3;

FIG. 6 is a view showing an internal structure of the electronic key shown in FIG. 3;

FIG. 7 is a block diagram showing a read/write circuit of the electronic key shown in FIG. 3;

FIG. 8 is diagrams for comparison between an emission switching control signal in the case of authentication success and an emission switching control signal in the case of authentication failure;

FIG. 9 is a view showing an internal structure of an electronic key in a second embodiment of the invention;

FIG. 10 is a cross sectional view taken along a line C-C in FIG. 9;

FIG. 11 is an electrical block diagram of an electronic key in a third embodiment of the invention;

FIG. 12 is a diagram showing a first modified example of a circuit of the electronic key shown in FIG. 1; and

FIG. 13 is a diagram showing a second modified example of the circuit of the electronic key shown in FIG. 1.

### REFERENCE SIGNS LIST

1 Electronic key
3 IC unit
9 LED
11, 2 First and Second terminals (plurality of terminals)
13 Contact IC chip
14, 15 First and Second switch circuits (Polarity switching means)
45 Data communication substrate (TC chip data reading means)
D1, D2 First and Second rectifier diodes (Circuit switching means)
R1, R2 First and Second resistors (Circuit switching means)

### DESCRIPTION OF EMBODIMENTS

A detailed description of a preferred embodiment of an electronic key embodying the present invention will now be given referring to the accompanying drawings.

### First Embodiment

### Whole Configuration of Lockable Storage Cabinet

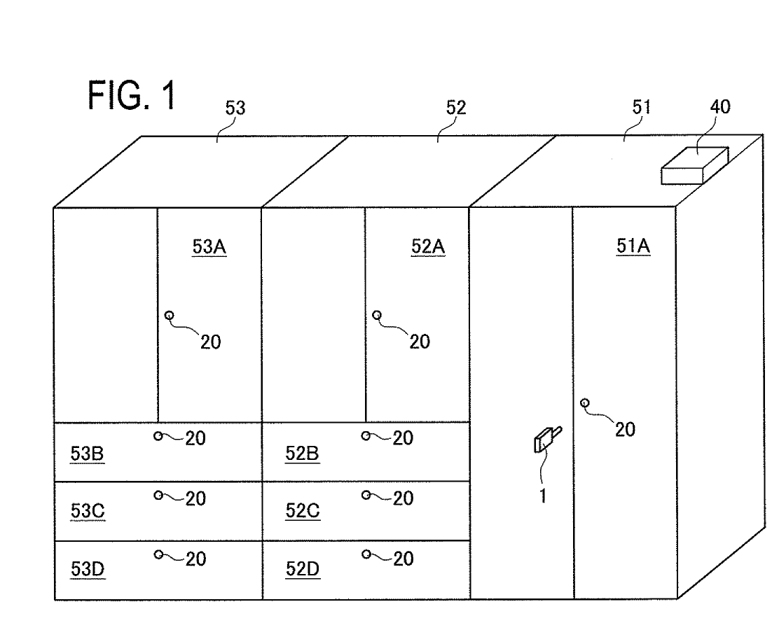

FIG. 1 is an external perspective view of lockable storage cabinets 51, 52, and 53 in a first embodiment of the invention.

In the first embodiment, three types of storage cabinets 51, 52, and 53 are placed contiguously. The storage cabinet 51 includes a double-doored storage box 51A. The storage cabinet 52 includes one double-doored storage box 52A and three drawer storage boxes 52B, 52C, and 52D. The storage cabinet 53 is identical in structure to the storage cabinet 52. Each of the storage boxes 51A, 52A, 52B, 52C, 52D, 53A, 53B, 53C, and 53D is provided with a lock 20 (one example of “opening and closing permitting means”) and stores therein a stored article(s). On an upper surface of the storage cabinet 51, a lock control means 40 (one example of the “opening and closing permitting means”) is provided to control opening and closing of each of the storage boxes 51A, 52A, 52B, 52C, 52D, 53A, 53B, 53C, and 53D of three storage cabinets 51, 52, and 53.

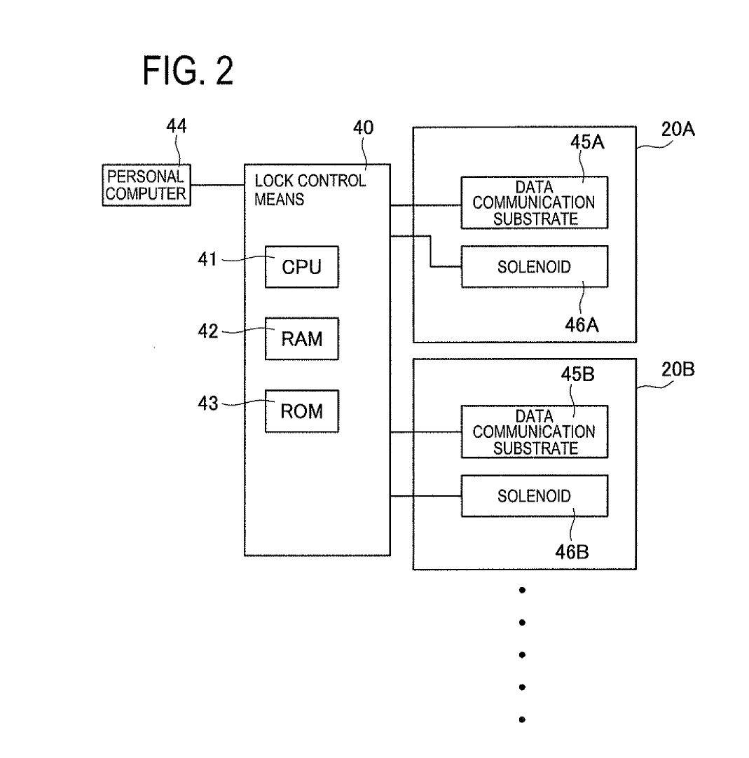

FIG. 2 is an electrical block diagram of the lock control means 40 shown in FIG. 1.

The lock control means 40 includes a CPU 41 for processing and calculating data, a ROM 43 for storing a control program, and a RAM 42 that previously stores ID data of a person(s) having the authority to open and close any storage boxes attached with the locks 20 and reads and writes various data and programs such as the data read from a contact IC chip. The lock control means 40 is linked with a personal computer 44 via LAN.

Each of locks 20A, 20B, 20C, . . . includes a data communication substrate (one example of “IC chip data reading means”) 45A, 45B, 45C, . . . for reading/writing data from/in the electronic key 1 and also a solenoid 46A, 46B, 46C, . . . for controlling rotation of each corresponding lock 20. The lock control means 40 is connected to the data communication substrates 45A, 45B, 45C, . . . and the solenoids 46A, 46B, 46C, . . . of the locks 20 respectively through wiring.

<Electronic Key>

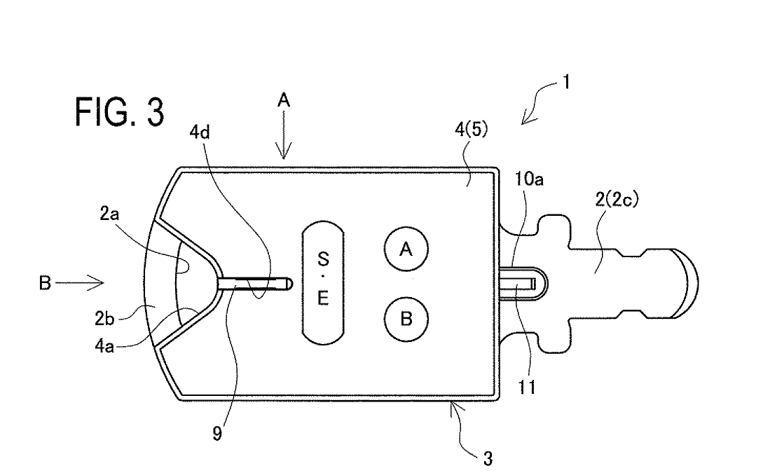

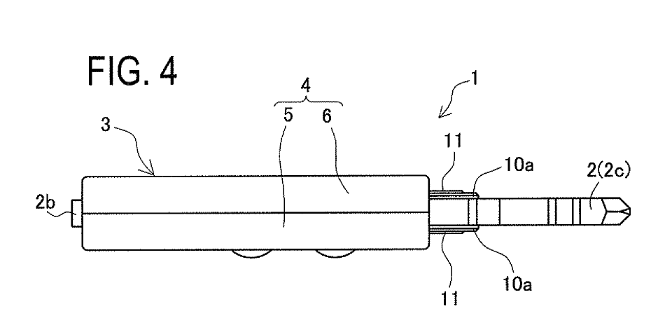

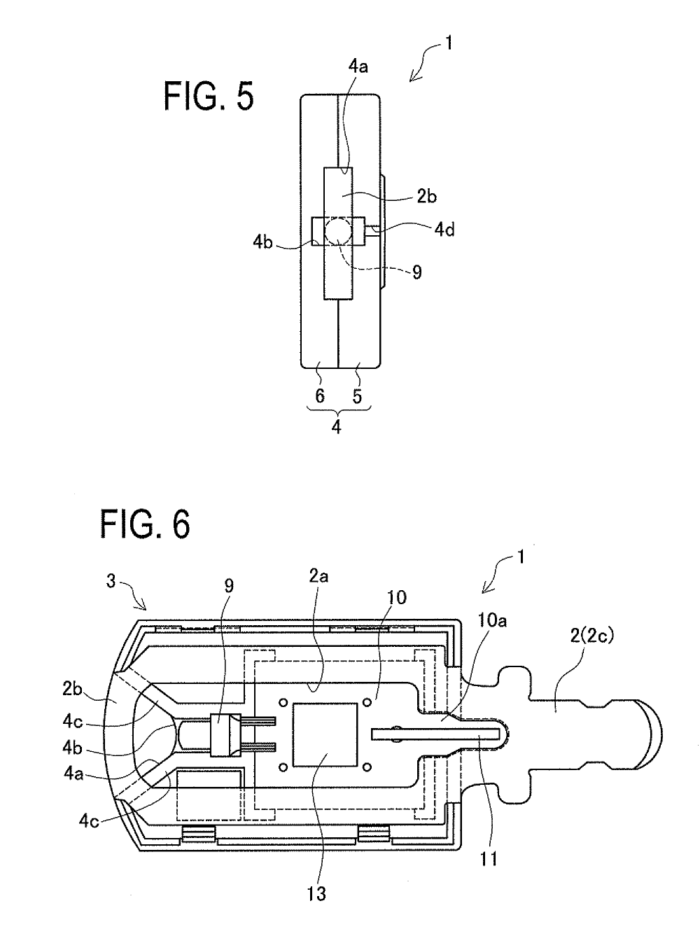

FIG. 3 is a plan view of the electronic key shown in FIG. 1. FIG. 4 is a side view seen from an arrow A in FIG. 3 and FIG. 5 is a side view seen from an arrow B in FIG. 3.

The electronic key 1 shown in FIG. 3 is configured such that first and second terminals (one example of a plurality of terminals) 11 and 2, each of which is made of metal such as stainless steel and protrudes from an IC unit 3 to be insertable in the lock 20. As shown in FIGS. 3 and 5, the IC unit 3 is configured to allow a light emitting state of an LED 9 to be visually observed on the side opposite to the protruding positions of the first and second terminals 11 and 2.

The IC unit 3 has an external appearance formed by a resin case 4. As shown in FIGS. 4 and 5, the case 4 includes a first case part 5 and a second case part 6 joined together, forming a hollow part therebetween. In the hollow part, a frame portion 2b of the second terminal 2 is housed. As shown in FIG. 3, the case 4 is provided with a recess 4a on the opposite side to an insert portion 2c to provide a hole for attachment of a key holder or the like between the frame portion 2b and the recess 4a.

FIG. 6 is a view showing an internal structure of the electronic key 1 shown in FIG. 3.

The frame portion 2b of the second terminal 2 is integrally provided with the insert portion 2c protruding out of the case 4. The case 4 contains a substrate 10 for IC chip. This substrate 10 mounts thereon a contact IC chip 13 and an LED 9. The substrate 10 is held in place in the case 4 so that the substrate 10 contacts with the frame portion 2b of the second terminal 2 while the IC chip 13 and the LED 9 are disposed within an opening 2a of the second terminal 2. A first terminal 11 is attached to the substrate 10. The first terminal 11 protrudes from both sides of the second terminal 2 (see FIG. 4). The first and second terminals 11 and 2 are insulated by an extended portion 10a provided to extend from the substrate 10.

On the substrate 10 for IC chip, the LED 9 is placed on the opposite side to the first terminal 11 and the insert portion 2c with respect to the IC chip 13. On the substrate 10, communication wiring for communication with the IC chip 13 through the first and second terminals 11 and 2, emission wiring for causing the LED 9 to emit light, and others are printed.

As shown in FIGS. 5 and 6, the IC unit 3 is formed with a cutout portion 4b in the inner surface of the recess 4a to allow visual observation of the light emitting state of the LED 9 from the opposite side to the first terminal 11 and the insert portion 2c. Furthermore, the IC unit 3 is also formed with an opening 4d in the side wall of the case 4 to similarly allow visual observation of the light emitting state of the LED 9.

Herein, the above contact IC chip 13 includes a CPU, a RAM, and a ROM which are not shown and has a communication function of communicating with an external device through the first and second terminals 11 and 2. The IC chip 13 stores an electronic key ID individually assigned to the IC chip 13 when manufactured, a personal ID for identifying a user, and a door ID (access right) for identifying a storage box the user authorized to open and close. In the first embodiment, the electronic key 1 is used as a personal key given to a person and an electronic key ID is used as the personal ID.

<Electric Circuit Configuration of Electronic Key>

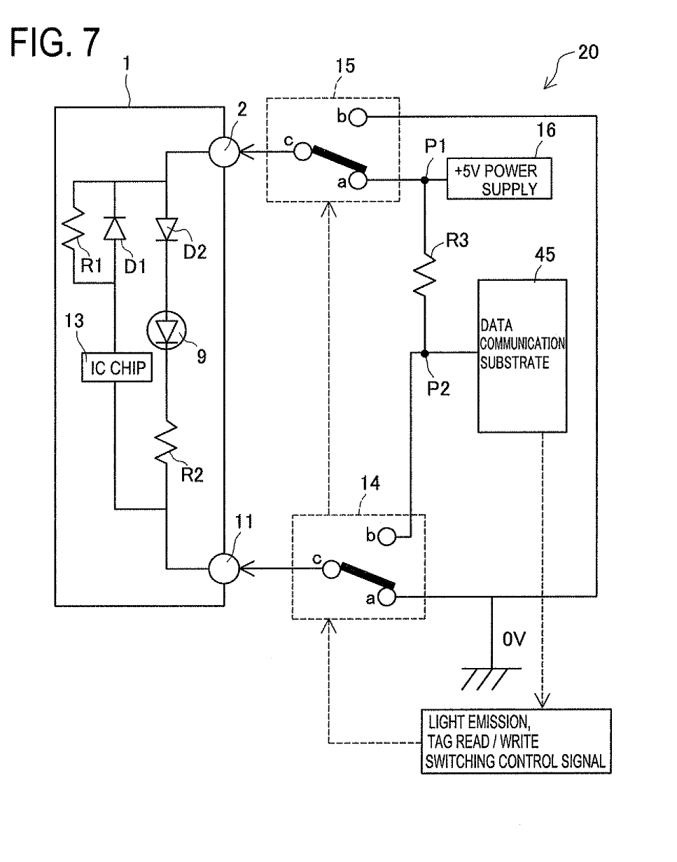

FIG. 7 is a block diagram showing the read/write circuit of the electronic key 1 shown in FIG. 3.

The read/write circuit shown in FIG. 7 is provided on the substrate 10 for IC chip. A first rectifier diode D1 has an anode coupled to the IC chip 13 and a cathode coupled to the first terminal 11 to allow a current to flow from the second terminal 2 to the first terminal 11. A first resistor R1 is arranged in parallel with the first rectifier diode D1. Even when a slight current flows in the contact IC chip 13 which is a nonlinear element, accordingly, the first rectifier diode D1 is switched to an ON state.

The LED 9 is arranged in parallel with the contact IC chip 13. A second rectifier diode D2 has an anode coupled to the first terminal 11 and a cathode coupled to the LED 9 to allow a current to flow from the first terminal 11 to the second terminal 2. A second resistor R2 is arranged between the LED 9 and the second terminal 2 to stabilize the current flowing in the LED 9. The first and second rectifier diodes D1 and D2 and the first and second resistors R1 and R2 constitute a “circuit switching means” for switching between a circuit for supplying a current to the IC chip 13 and a circuit for supplying a current to the LED 9.

<Electric Block Configuration of Lock>

As shown in FIG. 7, the lock 20 is configured such that a data communication substrate (board) 45 is coupled to a first switch circuit 14 connectable with the first terminal 11 of the electronic key 1 and a second switch circuit 15 connectable with the second terminal 2. The data communication substrate 45 outputs a control signal for changing the polarities of the first and second terminals 11 and 2 of the electronic key 1 (a light emission switching control signal (B) and (C)) and a tag read/write switching control signal (A) to the first and second circuits 14 and 15. By switching respective contact states of contacts “c” with contacts “a” and contacts “b”, the first and second circuits 14 and 15 switch between a communication circuit for supplying a current to the contact IC chip 13 and a shutoff circuit for supplying no current to both the LED 9 and the IC chip 13.

The contact “a” of the first switching circuit 14 and the contact “b” of the second switching circuit 15 are connected to ground. On the other hand, the contact “a” of the second switching circuit 15 is connected to a power supply 16. A contact P1 is provided between the contact “a” of the second switching circuit 15 and the power supply 16. The contact P1 is connected to the contact “b” of the first switching circuit 14 through a pull-up resistor R3. A contact P2 is provided between the contact “b” of the first switching circuit 14 and the pull-up resistor R3. The pull-up resistor R3 serves to stabilize the voltage at 5 V to be applied from the power supply 16 to the contact “a” of the first switching circuit 14, the contact “b” of the second switching circuit 15, and the data communication substrate 45.

When the data communication substrate 45 outputs the tag read/write switching control signal (A), the above first and second switching circuits 14 and 15 are both operated to connect respective contacts “c” to respective contacts “b”. Thus, the current output from the power supply 16 is allowed to flow to ground via the data communication substrate 45, the first switching circuit 14, the first terminal 11, the IC chip 13, the second terminal 2 of the electronic key 1, and the second switching circuit 15. In other words, a communication circuit is established. In this case, in the electronic key 1, the first terminal 11 is switched to a positive pole and the second terminal 2 is switched to a negative pole.

When the data communication substrate 45 outputs the light emission switching control signal (B) for causing the LED 9 to emit light, the first and second switching circuits 14 and 15 are both operated to connect respective contacts “c” to respective contacts “a”. Thus, the current output from the power supply 16 is allowed to flow to ground via the second switching circuit 15, the second terminal 2, the LED 9, the first terminal 11 of the electronic key 1, and the first switching circuit 14. In other words, a light-emission circuit is established. In this case, in the electronic key 1, the first terminal 11 is switched to a negative pole and the second terminal 2 is switched to a positive pole.

Furthermore, when the data communication substrate 45 outputs the light emission switching control signal (C) for not causing the LED 9 to emit light, the second switching circuit 15 is operated to connect the contact “c” to the contact “b” and the first switching circuit 14 is operated to connect the contact “c” to the contact “a”. Thus, no current is allowed to flow to both the first and second switching circuits 14 and 15. In other words, the shutoff circuit is established.

<Explanation of Operations>

The following explanation will be given to the operations of the lockable storage cabinets 51, 52, and 53 and the electronic key 1 to be used therefor.

For example, assuming that the electronic key 1 is a personal key for a person X, the contact IC chip 13 has stored doors ID of the storage boxes 51A, 52A, and 53A permitted for the person X to use.

Even during standby in which the electronic key 1 is not inserted in the lock 20, the lock control means 40 alternately outputs the tag read/write switching control signal (A) and the light emission switching control signal (B) for causing the LED 9 to emit light to the first and second switching circuits 14 and 15 through the data communication substrate 45, thereby alternately connecting the contacts “c” of the first and second switching circuits 14 and 15 to the contacts “b” or the contacts “a”. For example, the lock control means 40 outputs the tag read/write switching control signal (A) and the light emission switching control signal (B) to connect the contacts “c” of the first and second switching circuits 14 and 15 to the contacts “b” to form the communication circuit for a period of 1 to 2 msec. and connect the contacts “c” of the first and second switching circuits 14 and 15 to the contacts “a” to form the light-emission circuit for a period of 125 msec. to provide a large difference between the time period for forming the communication circuit and the time period for forming the light-emission circuit. Until the electronic key is inserted in the lock 20, the first and second switching circuits 14 and 15 are not electrically connected and thus no current flows in the data communication substrate 45. In this case, the lock control means 40 determines that the electronic key 1 is absent.

When the person X intends to take out a file or files from the storage box 52A, the person X goes to the lockable storage cabinet 52 and inserts the electronic key 1 in the lock 20 of the storage box 52A. When the electronic key 1 is inserted to bring the first and second terminals 11 and 2 into contact with the contacts “c” of the first and second switching circuits 14 and 15, these switching circuits 14 and 15 are rendered into an electrically connectable state through the electronic key 1. The lock control means 40 outputs the tag read/write switching control signal (A) and the light emission switching control signal (B) to the first and second switching circuits 14 and 15 in the same manner as during standby.

When the first and second switching circuits 14 and 15 are operated to connect respective contacts “c” to respective contacts “b” upon receipt of the tag read/write switching control signal (A), a current is allowed to flow to ground via the data communication substrate 45, the first switching circuit 14, the first terminal 11, the contact IC chip 13, the second terminal 2, and the second switching circuit 15. The lock control means 40 reads the electronic key ID and the door ID from the IC chip 13 of the electronic key 1 by the current flowing in the data communication substrate 45. At that time, no current flows in the LED 9 of the electronic key 1 and thus the LED 9 is not turned on.

On the other hand, when the first and second switching circuits 14 and 15 are operated to connect respective contacts “c” to respective contacts “a” upon receipt of the light emission switching control signal (B), a current is allowed to flow to ground via the second switching circuit 15, the second terminal 2, the LED 9, the first terminal 11, and the first switching circuit 14. Thus, the LED 9 of the electronic key 1 is turned on.

The lock control means 40 performs authentication by checking the electronic key ID and the door ID read from the IC chip 13 against the data stored in the RAM 42. Based on an authentication result, the lock control means 40 then selectively outputs the tag read/write switching control signal (A), the light emission switching control signal (B) for causing the LED 9 to emit light, and the light emission switching control signal (C) for not causing the LED 9 to emit light, to the first and second switching circuits 14 and 15.

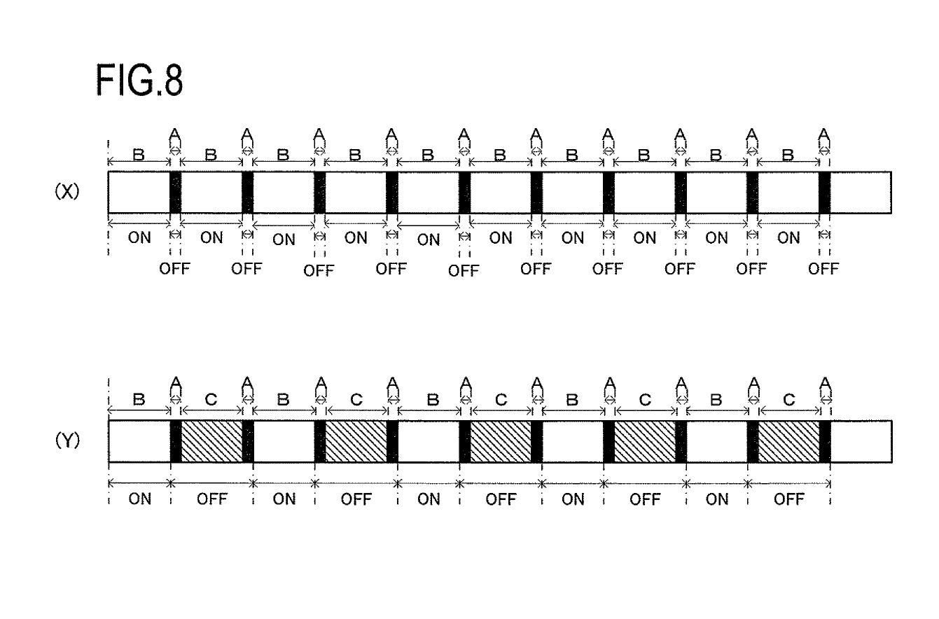

When the lock control means 40 authenticates the proper authority (authentication success) based on the electronic key ID of the IC chip 13 and the door ID, as shown by (X) in FIG. 8, the lock control means 40 outputs the tag read/write switching control signal (A) and the light emission switching control signal (B) for causing the LED 9 to emit light to the first and second switching circuits 14 and 15 at the same timing as that during standby. Therefore, the LED 9 of the electronic key 1 repeats turn-off for 1 to 2 msec. (see the areas filled with black in the figure) and turn-on for 125 msec. (see the areas filled with white in the figure). Since the turn-off time of the LED 9 is very shorter than the turn-on time, the LED 9 appears to human eyes to remain turned on by persistence of vision.

Furthermore, at the same time of authentication success, the lock control means 40 supplies a current to the solenoid 46 to unlock the lock 20.

As above, the person X confirms the authentication success by looking at continuous turn-on of the LED 9 of the electronic key 1 inserted in the lock 20. Thus, the person X turns the electronic key 1 in a normal direction to unlock the lock 20 and then takes out a file(s) from the storage box 52A. The person X then closes the door of the storage box 52A and turns the electronic key 1 in a reverse direction to lock the lock 20. When detects that the storage box 52A is closed, the lock control means 40 stops energization to the solenoid 46 to inhibit rotation of the lock 20. The lock control means 40 also stores the electronic key ID and the door ID in the RAM 42 and the contact IC chip 13 of the electronic key 1 by associating them with the opening and closing times of the storage box 52A. If only record of use stored in the RAM 42 and the IC chip 13 is read out, it is possible to know about which storage box is opened and closed by whom and when. In case a file or the like is lost, it is possible to ascertain a person responsible for the loss. Accordingly, a user must make sure locking to avoid such responsibility, thus enhancing security of stored articles such as a file(s) and others.

In some cases, the electronic key 1 is removed from the lock 20 before locking. After authentication success, the lock control means 40 outputs the tag read/write switching control signal (A) at the same timing as that during standby from the data communication substrate 45 to the first and second switching circuits 14 and 15 to monitor the presence/absence of the electronic key 1 (the presence/absence of the contact IC chip 13). Specifically, when the electronic key 1 is removed from the lock 20, the first and second switching circuits 14 and 15 are not electrically connected. Thus, even if the lock control means 40 outputs the tag read/write switching control signal (A), no current flows in the data communication substrate 45. The lock control means 40 therefore determines the presence/absence of the electronic key 1 based on whether or not a current flows in the data communication substrate 45 after authentication success.

In the case where a predetermined time has passed from the time when the lock control means 40 judges that the electronic key 1 is absent after authentication success, which represents that locking is wrongly omitted, the lock control means 40 writes the electronic key ID and the door ID in the RAM 42 in association with the time when the electronic key 1 is removed. It is therefore possible to identify which storage box was not locked by whom and when by reading the data from RAM 42.

Meanwhile, in the process of inserting the electronic key 1 into the lock 20, the first and second terminals 11 and 2 do not stably contact with the contacts “c” of the first and second switching circuits 14 and 15 and thus contact noise may occur. Contact noise usually converges within 50 msec. Accordingly, the lock control means 40 outputs the light emission switching control signal (B) to the first and second switching circuits 14 and 15 for 125 msec. and then outputs the tag read/write switching control signal (A) again. The contact noise is therefore likely to converge while the lock control means 40 outputs the light emission switching control signal (B). If the contact noise converges, the lock control means 40 is enabled to perform authentication and others as in the above.

However, the contact noise does not converge in case a contact failure occurs; for example, the contacts “c” of the first and second switching circuits 14 and 15 are pressed against the first and second terminals 11 and 2 with insufficient pressure or an oxide film sticks to the surfaces of the first and second terminals 11 and 2 or the contacts “c” of the first and second switching circuits 14 and 15. In such a case, the light emitting state of the LED 9 of the electronic key 1 is unstable in sync with the contact noise. The person X thus recognizes the occurrence of a contact failure by looking at unstable light emission of the LED 9 of the electronic key 1 inserted in the lock 20.

The person X therefore takes any action to solve the contact failure for example by: adjusting the pressure to press the contacts “c” of the first and second switching circuits 14 and 15 against the first and second terminals 11 and 2; repeating insertion and removal of the electronic key 1 in the lock 20 several times so as to rub the first and second terminals 11 and 2 with the contacts “c” of the first and second switching circuits 14 and 15, thereby removing the surface films sticking to the first and second terminals 11 and 2 and the contacts “c” of the first and second switching circuits 14 and 15; or scraping the surfaces of the first and second terminals 11 and 2 with nails to remove the oxide films. Then, the person X attempts to insert the electronic key 1 into the lock 20 again to unlock the lock 20.

If the lock control means 40 has properly read the electronic key ID and the door ID from the contact IC chip 13 of the electronic key 1 but fails to authenticate proper authority (authentication failure), the lock control means 40 alternately outputs the tag read/write switching control signal (A) and either one of the light emission switching control signal (B) for causing the LED 9 to emit light and the light emission switching control signal (C) for not causing the LED 9 to emit light as shown in (Y) in FIG. 8. At that time, the lock control means 40 outputs the tag read/write switching control signal (A) to form the communication circuit for a time period (1 to 2 msec.) equal to that in the case of authentication success. Furthermore, the lock control means 40 outputs the light emission switching control signal (B) for causing the LED 9 to emit light and the light emission switching control signal (C) for not causing the LED 9 to emit light to form the light-emission circuit and the shutoff circuit respectively for equal time periods (125 msec.).

While the lock control means 40 outputs the tag read/write switching control signal (A) to form the communication circuit, a current flows in the IC chip 13 of the electronic key 1 but does not flow in the LED 9. Thus, the LED 9 is in a turn-off state as indicated by the black-filled areas in the figure. On the other hand, while the lock control means 40 outputs the light emission switching control signal (B) for causing the LED 9 to emit light, a current does not flow in the IC chip 13 of the electronic key 1 but flows in the LED 9. Thus, the LED 9 is in a turn-on state as indicated by the white-filled areas in the figure. Furthermore, while the lock control means 40 outputs the light emission switching control signal (C) for not causing the LED 9 to emit light, thereby forming the shutoff circuit, the first and second switching circuits 14 and 15 are not connected to the power supply 16 and hence a current flows to neither the IC chip 13 nor the LED 9 of the electronic key 1. Thus, the LED 9 is turned off as indicated by the diagonally shaded areas in the figure. The lock control means 40 forms the light-emission circuit and the shutoff circuit respectively for equal time periods (125 msec.) and turn-on and turn-off cycles are slow. Accordingly, the LED 9 appears to human eyes to blink by alternately turning on and off at intervals of 125 msec.

By looking that the LED 9 of the electronic key 1 inserted in the lock 20 quickly blinks at constant intervals, the person X recognizes that the authentication is failed.

Herein, the light of the LED 9 goes out from a side surface and the rear (on an opposite side to the first terminal 11 and the insert portion 2c) of the IC unit 3. The person X can therefore see the light emitting state (continuous turn-on, blinking, etc.) of the LED 9 from his/her standing position without peering through the IC unit 3.

<Operations and Advantages>

As explained above, the electronic key 1 in the first embodiment includes the contact IC chip 13 to be connected in series to the first and second terminals 11 and 2. The data of the IC chip 13 is read by the current flowing between the first and second terminals 11 and 2. The electronic key 1 is provided with the LED 9 in parallel to the IC chip 13. The LED 9 is turned on through the use of the current flowing between the first and second terminals 11 and 2.

To unlock the lock 20 of the storage box 52A, for example, the electronic key 1 is inserted in the lock 20 of the storage box 52A so as to bring the first and second terminals 11 and 2 into contact with the first and second switching circuits 14 and 15. By turning on the LED 9, the electronic key 1 indicates to the user that the first and second terminals 11 and 2 are in proper contact with the first and second switching circuits 14 and 15 and the data has been properly read from the IC chip 13. In case the lock 20 of the storage box 52A could not be unlocked, for example, the user considers a cause thereof as resulting from something other than a contact failure.

On the other hand, by not turning on the LED 9, the electronic key 1 indicates to the user that the first and second terminals 11 and 2 are not in proper contact with the first and second switching circuits 14 and 15 and hence the data is not properly read from the IC chip 13. In case the lock 20 of the storage box 52A could not be unlocked, for example, the user considers a cause thereof as resulting from a contact failure.

According to the electronic key 1 in the first embodiment, it is possible to indicate to the user the operating state of the electronic key 1 by distinguishing the operating state. As a result, in case the LED 9 is not turned on, the user attempts to take any actions to solve the contact failure for example by pulling the electronic key 1 out of the lock 20 and removing the contact films on the first and second terminals 11 and 2 and the contacts c 14c and 15c of the first and second switching circuits 14 and 15. Then, the user inserts the electronic key 1 into the lock 20 again. If the contact failure of the first and second terminals 11 and 2 is resolved as above, proper data can be read from the IC chip 13 and the lock 20 can be unlocked. In this way, the user is able to take any actions suitable for the operating state of the electronic key 1. In case of contact failures, therefore, it is possible to avoid disadvantages that data is stored again in the electronic key 1 and a still available electronic key 2 is wastefully replaced.

In particular, the electronic key 1 in the first embodiment performs power supply and data communication by use of the first and second terminals 11 and 2 and thus differs in electric structure from a USB memory using separate terminals for power supply and data communication. Therefore, the electronic key 1 can indicate to the user a data reading state of the IC chip 13 by the light emitting state of the LED 9 through a simple electric circuit in which the LED 9 is connected in parallel to the IC chip 13.

In addition, the contact IC chip 13 is lower cost than a non-contact IC chip but it may cause a contact failure due to surface films or the like, which is likely to disturb communication. Therefore, the non-contact IC chip is conventionally considered to be higher in reliability than the contact IC chip 13 and widely used. However, the electronic key 1 in the first embodiment is configured to indicate to the user the presence/absence of a contact failure by the light emitting state of the LED 9. Accordingly, the user is able to recognize and improve, for himself/herself, the contact failure of the electronic key 1 in use. Even when the electronic key 1 including the contact IC chip 13 is used in various storage cabinets such as a book storage cabinet, a locker, and a desk, the electronic key 1 can reliably authenticate authority, thereby enhancing security of each storage cabinet at low cost.

The electronic key 1 in the first embodiment switches the light emitting mode of the LED 9 by distinguishing between the case where proper authority is authenticated based on the data read from the contact IC chip 13 and the case where proper authority is not authenticated based on the data read from the contact IC chip 13. For instance, when the proper authority is not authenticated, the electronic key 1 causes the LED 9 to blink at equal intervals. In this case, the user who looks at the blinking LED 9 recognizes that the lock 20 of the storage box 52A is not unlockable because of authentication failure. On the other hand, when the proper authority is authenticated, the electronic key 1 extremely shortens the turn-off time, thereby causing the LED 9 to blink. In this case, the LED 9 appears to the user to remain turned on by persistence of vision. By continuous turn-on of the LED 9, the user then recognizes that authentication is successful and the lock 20 of the storage box 52A is unlockable. According to the electronic key 1 in the first embodiment, it is possible to indicate to the user an authentication success or failure based on the difference in light emitting mode of the LED 9.

The electronic key 1 in the first embodiment includes the IC unit 3 containing the contact IC chip 13 and the LED 9 internally and holding the first and second terminals 11 and 2 placed protruding outside. On the opposite side to the protruding position of the first and second terminals 11 and 2, the IC unit 3 is provided with the cutout portion 4b and the opening 4d through which the light of the LED 9 goes out. Accordingly, even when the electronic key 1 is inserted in the lock 20, the light emitting state of the LED 9 is easy to see.

The electronic key 1 in the first embodiment is configured such that the circuit is formed between the two terminals so that a current flowing in the contact IC chip 13 and a current flowing in the LED 9 are opposite in direction. The electronic key 1 includes the circuit switching means for alternately performing driving of the contact IC chip 13 and the turn-on of the LED 9 by switching the polarities of the two terminals by the switching control signals (A) and (B). Such electronic key 1 can easily change the light emitting mode of the LED 9 by distinguishing among a contact failure, an authentication failure, and an authentication success.

### Second Embodiment

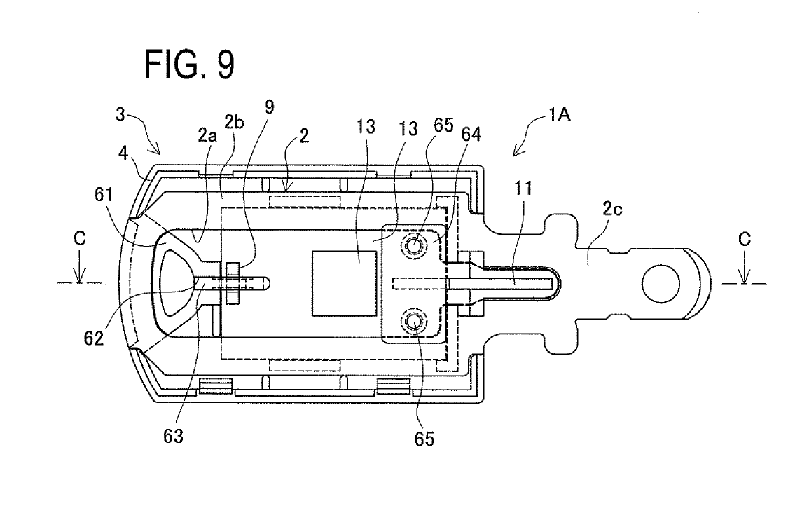

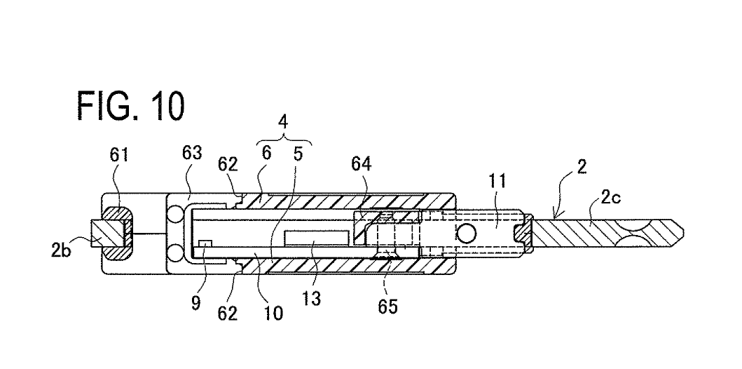

Next, a second embodiment of the electronic key of the invention will be described below. FIG. 9 is a view showing an internal structure of an electronic key 1A in the second embodiment. FIG. 10 is a cross sectional view taken along a line C-C in FIG. 9.

The electronic key 1A in the second embodiment is identical to that in the first embodiment excepting a surrounding structure of the LED 9. Herein, the following explanation is focused on differences from the first embodiment. Identical parts or components to those in the first embodiment are given the same reference signs as those in the first embodiment and their details are appropriately omitted.

In the electronic key 1A, a cover member 61 of the case 4 covers the inner periphery of the frame portion 2b in order to prevent a metal part or element of a key holder from touching the frame portion 2b. The IC unit 3 is provided with cutout portions 62 in a position corresponding to the LED 9. The cutout portions 62 are formed on the opposite side to the insert portion 2c of the IC unit 3. In the cutout portions 62, a dispersing member 63 is set to disperse the light of the LED 9.

In the electronic key 1A, the first terminal 11 is attached to the second terminal 2 through an insulating member 64. The insulating member 64 is secured to the substrate 10 with locking screws 65, thereby positioning the first terminal 11 in contact with wiring on the substrate 10.

In this electronic key 1A, the light of the LED 9 is dispersed by the dispersing member 63, thereby allowing the light emitting state of the LED 9 to be easily viewed. After the electronic key 1A is inserted in the lock 20, therefore, it is easy to see the continuous turn-on of the LED 9 caused when the first and second terminals 11 and 2 properly contact with the first and second switching circuits 14 and 15 and proper authority is authenticated and the blinking of the LED 9 caused when the first and second terminals 11 and 2 properly contact with the first and second switching circuits 14 and 15 but proper authority is not authenticated. Thus, this electronic key 1A is convenient.

### Third Embodiment

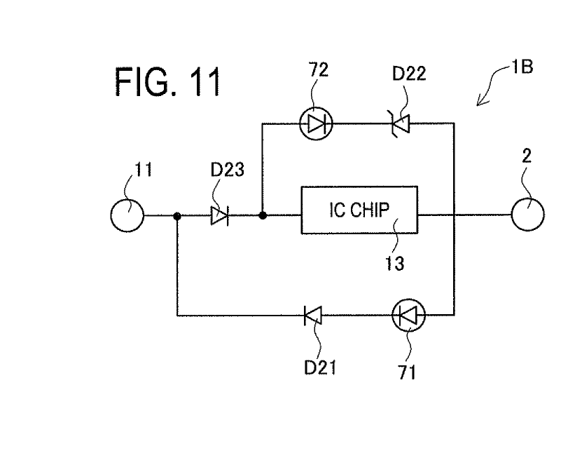

Next, a third embodiment of the electronic key of the invention will be described. FIG. 11 is an electrical block diagram of the electronic key in the third embodiment of the invention.

An electronic key 1B in the third embodiment is identical to that in the first embodiment excepting the use of a plurality of LEDs 71 and 72 to indicate to a user a contact failure, an authentication failure, and an authentication success. Herein, the following explanation is therefore focused on differences from those in the first embodiment and identical parts and components to those in the first embodiment are given the same reference signs and their details are appropriately omitted.

As shown in FIG. 11, the electronic key 1B is configured such that the IC chip 13 is placed between the first terminal 11 and the second terminal 2. Between the first terminal 11 and the IC chip 13, a rectifier diode D23 is placed to allow a current to flow from the second terminal 2 to the first terminal 11 via the IC chip 13.

A point between the diode D23 and the IC chip 13 is connected to a point between the IC chip 13 and the second terminal 2, and a blue LED 72 is arranged in parallel with the IC chip 13. On a second terminal 2 side of the blue LED 72, a Zener diode D22 is placed. When a voltage of a predetermined value or higher is applied to the second terminal 2, a current is allowed to flow from the second terminal 2 to the first terminal 11 via the blue LED 72. According to a value of voltage to be applied to the second terminal 2, it is possible to control turn-on and turn-off of the blue LED 72.

A point between the second terminal 2 and the IC chip 13 is connected to a point between the first terminal 11 and the diode D23, and a red LED 71 is arranged in parallel with the IC chip 13. On a first terminal 11 side of the red LED 71, a rectifier diode D21 is placed. Thus, the red LED 71 is caused to emit light by a current flowing from the first terminal 11 to the second terminal 2.

The above electronic key 1B is configured such that, when its existence is confirmed by the lock 20, the first terminal 11 and the second terminal 2 are alternately supplied with a current in order to check contact states of the first and second terminals 11 and 2. In case the first and second terminals 11 and 2 have contact failures, causing contact noise, the light emitting states of the red LED 71 and the blue LED 72 are unstable.

On the other hand, when the first and second terminals 11 and 2 properly contact with the first and second switching circuits 14 and 15, both the red LED 71 and the blue LED 72 are allowed to stably emit light. When authority authentication of the electronic key 1 is successful, a current of a predetermined voltage or higher is applied to the second terminal 2. Accordingly, a current flows in the contact IC chip 13 and the blue LED 72 but does not flow in the red LED 71. When authority authentication of the electronic key 1B is successful, the blue LED 72 is continuously turned on and also the presence/absence of the IC chip 13 is detected and data is read from or written in the IC chip 13. Thus, turn-on of the blue LED 72 enables the user to know that the first and second terminals 11 and 2 of the electronic key 1B are in proper contact with the first and second switching circuits 14 and 15 and data is read from the IC chip 13 and that authentication is successful.

When a predetermined time has passed from turn-on of the blue LED 72, a voltage to be applied to the second terminal 2 the electronic key 1b is decreased than the predetermined value. Thus, current no longer flows in the blue LED 72 and only data reading from the contact IC chip 13 is performed. It is accordingly possible to save the electricity needed for turning on the LED 72.

On the other hand, in case authority authentication of the electronic key 1B is not successful, a current is supplied from the lock 20 to the first terminal 11. Thus, the current does not flow in the contact IC chip 13 and the blue LED 72 but does flow in the red LED 71. When authentication of the electronic key 1B is failed, the red LED 71 is therefore caused to continuously emit light. Accordingly, the user can know that the first and second terminals 11 and 2 of the electronic key 1B normally contact with the first and second switching circuits 14 and 15 but authentication is failed.

According to the electronic key 1B in the third embodiment, it is possible to indicate to the user that the function is inhibited due to a contact failure by distinguishing it based on turn-on or turn-off of the red LED 71 or blue LED 72.

According to the electronic key 1B in the third embodiment, it is possible to indicate to the user about whether authentication is successful or not based on which one of the blue LED 72 and the red LED 71 is turned on.

The present invention may be embodied in other specific forms without departing from the essential characteristics thereof.

(1) In the above embodiments, the first and second switching circuits 14 and 15 are used to switch the circuits. As an alternative, the first and second switching circuits 14 and 15 may be changed to durable semiconductors to switch the circuits.

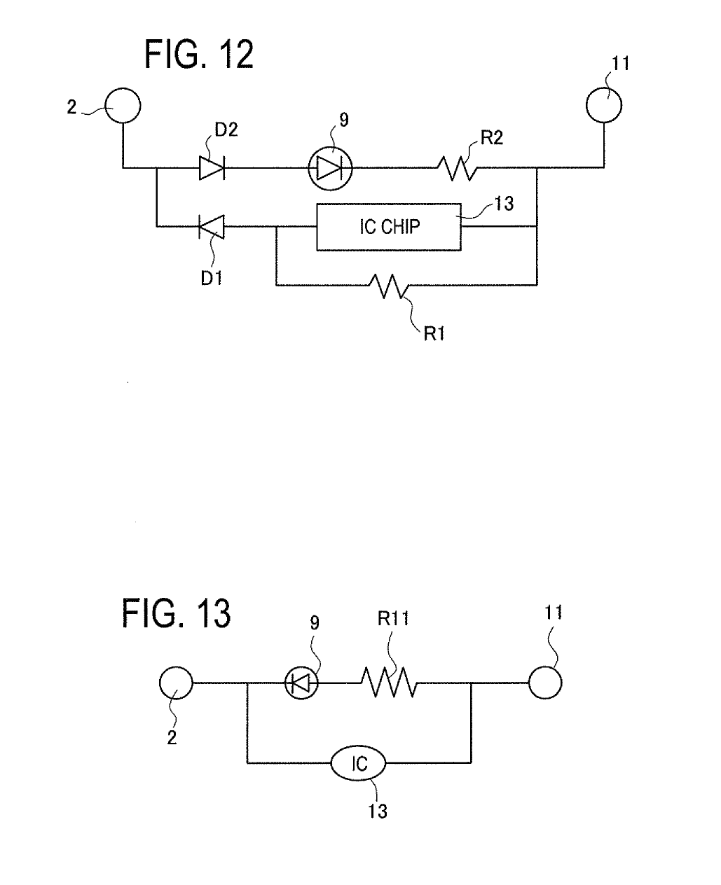

(2) The electronic circuit configuration of the electronic key 1 described in the above embodiment may be changed to that shown in FIG. 12. An electronic key including the electronic circuit shown in FIG. 12 is different from the electronic circuit (see FIG. 7) of the electronic key in the above embodiments in that the first resistor R1 is connected in parallel with the IC chip 13. In the case where the first terminal 11 is switched to a positive pole and the second terminal 2 is switched to a negative pole, the electronic circuit shown in FIG. 12 also allows a current to flow via the IC chip 13 and the first rectifier diode D1 to read and write data with respect to the IC chip 13. By switching the polarities of the first and second terminals 11 and 12, the LED 9 is enabled to turn on.

(3) The electronic circuit of the electronic key 1 explained in the above embodiment is configured such that the current flowing directions are opposite between the IC chip 13 and the LED 9. On the other hand, as shown in FIG. 13, the current flowing directions in the IC chip 13 and the LED 9 may be the same. In this case, the light emitting mode of the LED 9 is preferably changed by changing the cycle of current to be supplied in pulse form to the first terminal 11. Furthermore, the voltage to be applied to the first terminal 11 may be switched between high voltage and low voltage to control luminance of the LED 9. The blinking intervals of the LED 9 may be changed by the cycle of switching between high voltage and low voltage.

(4) In the above embodiments, the light emitting state of the LED 9 may be different between the case where data is not readable from the IC chip 13 and the case where data is readable from the IC chip 13. For instance, when data can be read, the first and second terminals 11 and 2 are simultaneously switched to ON/OFF to blink the LED 9 at predetermined intervals. On the other hand, when data cannot be read, the one terminal 11 is continuously held ON and the other terminal 2 is switched to ON/OFF to change the blinking time of the LED 9 to be shorter (longer) than that in the case where data can be read.

(5) In the above embodiments, after a predetermined time (e.g., 30 seconds) has passed from the time when data is properly read from the IC chip 13 and the LED 9 is turned on, the LED 9 may be turned off while the electronic key 1 remains inserted in the lock. This is because a user has only to first confirm by seeing turn-on of the LED 9 that data has been properly read from the IC chip 13. By shortening the turn on time of the LED 9 to save power, the life of a battery can be extended.

(6) In the above embodiments, blinking of the LED 9 and the data reading/writing with respect to the IC chip 13 are performed at the same cycles. Alternatively, the blinking of the LED 9 and the data reading/writing of the IC chip 13 may be controlled at any different cycles by the tag read/write switching control signal (A) and the light emission switching control signals (B) and (C). Also in this case, since a persistence of vision of the LED 9 is left to human eyes, the LED 9 can appear to emit light, thereby showing that data is read from and written in the IC chip 13. Furthermore, for example, the blinking time of the LED 9 may be shortened than the data reading/writing of the IC chip 13, thereby distinctively informing a user of the electronic key 1 about the contact state of the first and second terminals 11 and 2 and the data reading/writing state of the IC chip 13.

(7) The electronic key 1 may also be used for office furniture such as a desk and a door other than the storage cabinet, and other items.

(8) In the above embodiment, the lock control means 40 of the storage cabinet is connected to the personal computer 44 via LAN. On the other hand, a lock unit may be provided in each storage box on a stand-alone basis. This lock unit includes a battery, a lock, an IC chip data reading means for reading data from a contact IC chip, an authentication device for authenticating personal identification based on the data of the IC chip, a solenoid for inhibiting rotation of the lock, and a solenoid control device arranged to supply a current of the battery to the solenoid when the authentication device authenticates personal identification, thereby unlocking the rotation inhibited state of the lock. In this case, similarly, if the IC chip data reading means of the lock unit causes a contact failure with the first and second terminals 11 and 2 and data cannot be read from the IC chip 13, the current does not flow from the battery to the LED 9 of the electronic key 1 and thus the LED 9 is not turned on. The electronic key 1 is able to indicate to a user by blinking of the LED 9 that the data cannot be read from the IC chip 13.

(9) In the above embodiments, two terminals are provided to be connected to the contact IC chip 13. Alternatively, three or more terminals may be connected to the IC chip 13 to read data from the IC chip 13.

(10) In the above embodiments, the IC chip 13 of the electronic key 1 has stored the electronic key ID and the door ID. Alternatively, the IC chip 13 of the electronic key 1 may store one or more of the electronic key ID, the user ID, and the door ID so that each ID is used for authority authentication.

1-4. (canceled)

5. An authentication system comprising: an electronic key including a contact IC chip provided with two terminals; a data reading means for contacting with the contact IC chip and reading data therefrom; and an authentication means for performing authority authentication based on the data read by the data reading means,
wherein the electronic key comprises an LED arranged between the two terminals and in parallel to the contact IC chip and caused to turn on by use of a current allowed to flow between the two terminals, and
an LED emitting state switching means for bringing the LED into a first emitting state when the authentication means does not authenticate proper authority and for bringing the LED into a second emitting state different from the first emitting state when the authentication means authenticates proper authority, and
when the two terminals are out of proper contact with the data reading means, the LED is not turned on to thereby indicate that the data reading means does not read data from the contact IC.

6. The authentication system according to claim 5, wherein
the electronic key includes an IC unit containing the contact IC chip and the LED and holding the two terminals protruding outside, and
the IC unit is provided with a cutout portion through which light of the LED goes out, the cutout portion being located on an opposite side to a protruding position of the two terminals.

7. The authentication system according to claim 5, wherein the electronic key includes:
an electrical circuit to be formed between the two terminals so that a direction of a current flowing in the contact IC chip and a direction of a current flowing in the LED are opposite; and
a circuit switching means for alternately performing driving of the contact IC chip and turn-on of the LED by switching polarities of the two terminals based on a control signal transmitted from the data reading means.

8. An electronic key to be used in the authentication system according to claim 5.

9. A storage cabinet mounting the authentication system according to claim 5.

10. An electronic key to be used in the storage cabinet according to claim 9.
